(19) United States
(12) Patent Application Publication
(10) Pub. No.: US 2025/0058811 A1
(43) Pub. Date: Feb. 20, 2025

(54) Folding Cart

(71) Applicant: Zhejiang Pride Leisure Products Co,. Ltd., Jinhua (CN)

(72) Inventor: Benlong SUN, Jinhua (CN)

(21) Appl. No.: 18/805,477

(22) Filed: Aug. 14, 2024

(30) Foreign Application Priority Data
Aug. 14, 2023 (CN) 202322180768.9

(51) Int. Cl. B62B 3/02; B62B 5/04; B62B 5/06

(52) U.S. Cl. CPC B62B 3/02; B62B 5/0433; B62B 5/064; B62B 5/067; B62B 2205/26

(57) ABSTRACT

A folding cart having a frame and casters mounted at the bottom of the frame. The frame having a plurality of pillars, a plurality of pairs of bottom folding frames hinged to the pillars, and a plurality of pairs of transverse folding frames and longitudinal folding frames hinged between the pillars, such that four sides of the folding cart can be folded. Fixing blocks are mounted at top ends of the pillars, slidable sliders are arranged on the pillars, lower ends of outer sides of the transverse folding frames and the longitudinal folding frames are hinged to the sliders, upper ends of the outer sides of the transverse folding frames and the longitudinal folding frames are hinged to the fixing blocks, and the sliders slide to drive the transverse folding frames and the longitudinal folding frames to be folded or unfolded.

### BACKGROUND OF THE INVENTION

### 1. Technical Field

The invention relates to the technical field of carts, in particular to a folding cart.

### 2. Description of Related Art

Nowadays, outdoor activities, as leisure and fashionable activities, are becoming increasingly popular, and in most cases, people need to carry a large quantity of personal items and items for activities when taking part in outdoor activities. When driving to the activity place, people may have to manually transfer the items to the destination, which is labor intensive and ruins the atmosphere of the outdoor activities. In view of this, folding carts have emerged on the market, and a large quantity of items can be placed on the carts to be pushed or pulled to the destination, thus saving a large amount of physical effort. In addition, the folding carts can be folded, and thus will not occupy a large space when not used, and are easy to carry when people go out.

As for existing folding carts, Chinese Patent Publication No.CN218858468U discloses a standing type folding cart, comprising a bottom frame horizontal support, wherein bottom frame bodies are arranged on two sides of the bottom frame horizontal support respectively, folding cart frames are hinged to outer sides of the bottom frame bodies through rotating shafts, a fixing frame is arranged at the top of the bottom frame horizontal support, a hand grip is mounted at the top of the fixing frame, standing links are mounted on the outer sides of the bottom frame bodies, metal brackets are arranged at bottoms of the bottom frame bodies, casters are hinged into the metal brackets through rotating shafts, standing legs are arranged on outer sides of the metal brackets, standing support devices extending to the outside are arranged in the standing legs, movable frames are arranged on outer sides of the folding cart frames, and a reinforcing rod is hinged between inner walls of two sides of each folding cart frame through a rotating shaft.

The folding cart can be partially folded by means of the folding cart frames on left and right sides. However, because cart frames on front and back sides of the cart cannot be folded, the folding cart cannot be completely folded, thus still occupying a large space after being folded, and leading to unsatisfying user experience.

### BRIEF SUMMARY OF THE INVENTION

To overcome the defects in the prior art, the invention provides a folding cart. To solve the abovementioned technical problems, the invention provides the following technical solution:

A folding cart comprises a frame and casters mounted at a bottom of the frame, wherein the frame comprises a plurality of pillars, a plurality of pairs of bottom folding frames hinged to the pillars, and a plurality of pairs of transverse folding frames and longitudinal folding frames hinged between the pillars, fixing blocks are mounted at top ends of the pillars, sliders are arranged on the pillars and slide at lower ends of the pillars, lower ends of outer sides of the transverse folding frames and the longitudinal folding frames are hinged to the sliders, upper ends of the outer sides of the transverse folding frames and the longitudinal folding frames are hinged to the fixing blocks, and the sliders slide vertically to drive the transverse folding frames and the longitudinal folding frames to be folded or unfolded.

Further, the transverse folding frame comprises a plurality of pairs of transverse rod assemblies which are connected in a hinged manner, and the longitudinal folding frame comprises a plurality of pairs of longitudinal rod assemblies connected in a hinged manner.

Further, the transverse rod assembly comprises a first transverse rod and a second transverse rod which are movably riveted together, and the longitudinal rod assembly comprises a first longitudinal rod and a second longitudinal rod which are movably riveted together.

Further, ends of two adjacent first transverse rods and two adjacent second transverse rods are hinged to fix the transverse rod assemblies; ends of two adjacent first longitudinal rods and two adjacent second longitudinal rods are hinged to fix the longitudinal rod assemblies; the first transverse rods are hinged to the fixing blocks at the top ends of the pillars, and the second transverse rods are hinged to the sliders at the lower ends of the pillars; and the first longitudinal rods are hinged to the fixing blocks at the top ends of the corresponding pillars, and the second transverse rods are hinged to the sliders at the lower ends of the corresponding pillars.

Further, the bottom folding frame comprises a connecting seat at a center and a plurality of bottom rods, and inner ends of the bottom rods are hinged to the connecting seat.

Further, fixing members are connected to outer ends of the bottom rods in a hinged manner and mounted at bottom ends of the corresponding pillars, and the outer ends of the bottom rods are connected to the bottom ends of the corresponding pillars by means of the fixing members; and the sliders slide between the fixing members and the fixing blocks.

Further, the connecting seat is provided with a plurality of hinge slots which are open downwards, and the bottom rods are hinged in the hinge slots.

Further, a pull frame is arranged at a front end of the frame and comprises a fixing seat, connecting rods located on two sides of the fixing seat, and a pull rod hinged to the fixing seat, inner ends of the connecting rods are hinged to the fixing seat, and outer ends of the connecting rods are hinged to fixing members on two sides.

Further, a grip ring is arranged at a top end of the pull rod.

Further, brake pedals are arranged at a front end of the frame and located above the casters at the front end of the frame.

Compared with the prior art, the invention can fulfill the following beneficial effects:

In the invention, the frame comprises a plurality of pillars, a plurality of pairs of bottom folding frames hinged to the pillars, and a plurality of pairs of transverse folding frames and longitudinal folding frames hinged between the pillars, the transverse folding frames can be folded in the transverse direction, and the longitudinal folding frames can be folded in the longitudinal direction, such that four sides of the folding cart can be folded, thus further reducing the space occupied by the cart in the folded state and making the folding cart easy to carry when users go out. Fixing blocks are mounted at top ends of the pillars, sliders are arranged on the pillars and slide at lower ends of the sliders, lower ends of outer sides of the transverse folding frames and the longitudinal folding frames are hinged to the sliders, upper ends of the outer sides of the transverse folding frames and the longitudinal folding frames are hinged to the fixing blocks, and the sliders at the lower ends of the pillars slide vertically to drive the transverse folding frames and the longitudinal folding frames to be folded or unfolded, such that the folding cart can be easily folded or unfolded and be easily used by users.

### BRIEF DESCRIPTION OF THE SEVERAL VIEWS OF THE DRAWINGS

FIG. 1 is an unfolded three-dimensional view of the invention.

FIG. 2 is a front view of the invention.

FIG. 3 is a left view of the invention.

FIG. 4 is a bottom view of the invention.

FIG. 5 is a folded three-dimensional view of the invention.

Reference signs: 1, frame; 2, caster; 3, pillar; 4, bottom folding frame; 5, transverse folding frame; 6, longitudinal folding frame; 7, fixing block; 8, slider; 9, transverse rod assembly; 10, longitudinal rod assembly; 11, first transverse rod; 12, second transverse rod; 13, first longitudinal rod; 14, second longitudinal rod; 15, connecting seat; 16, bottom rod; 17, fixing member; 18, hinge slot; 19, pull frame; 20, fixing seat; 21, pull rod; 22, connecting rod; 23, pull ring; 24, brake pedal.

### DETAILED DESCRIPTION OF THE INVENTION

The technical solutions of the embodiments of the invention will be clearly and completely described below in conjunction with the accompanying drawings of the embodiments of the invention. Obviously, the embodiments in the following description are merely illustrative one, and are not all possible ones of the invention. All other embodiments obtained by those ordinarily skilled in the art based on the following ones without creative labor should fall within the protection scope of the invention.

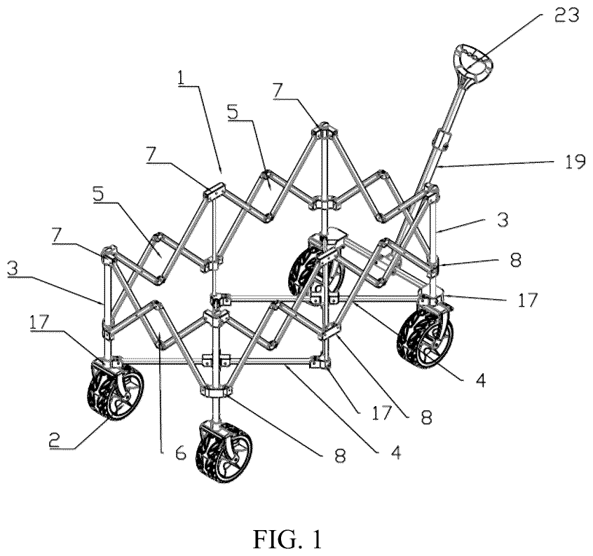

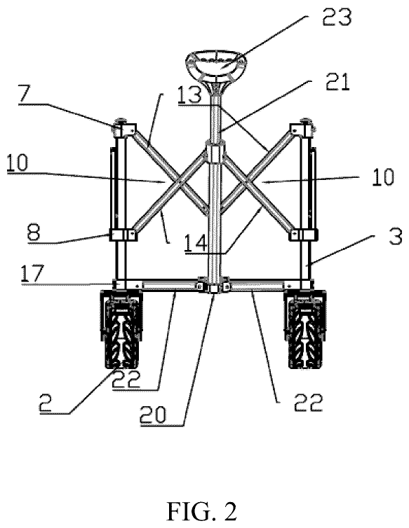

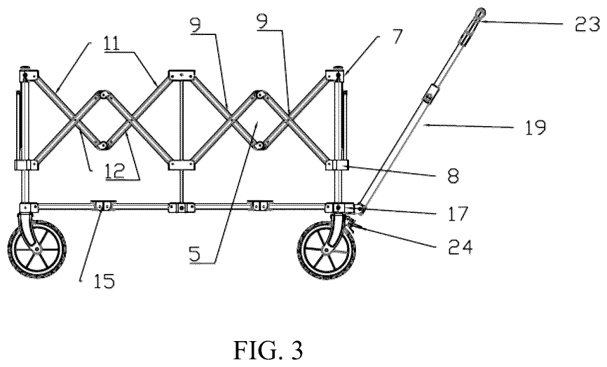

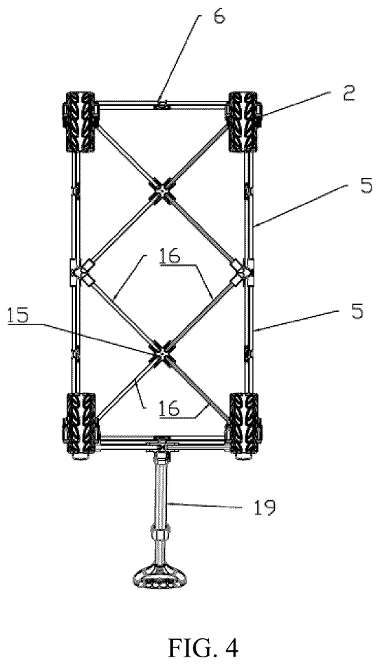

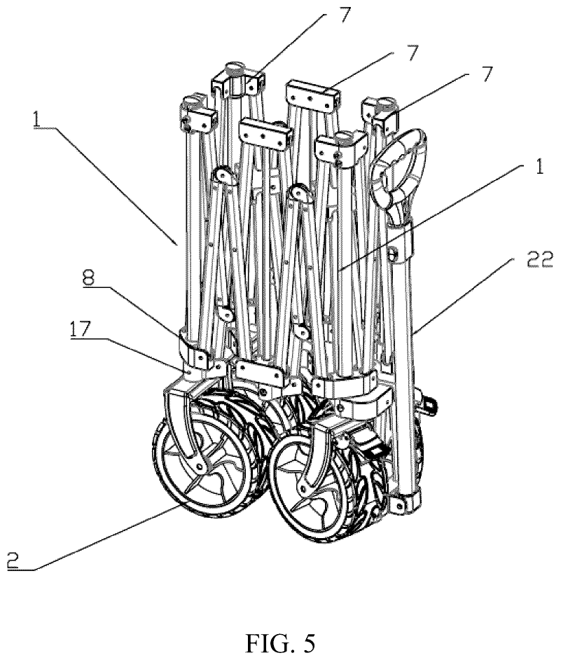

As shown in FIG. 1-FIG. 5, a folding cart comprises a frame 1 and casters 2 mounted at the bottom of the frame 1, wherein the frame 1 comprises six pillars 3, two pairs of bottom folding frames 4 hinged to the pillars 3, and transverse folding frames 5 and longitudinal folding frames 6 hinged between the pillars 3; and each transverse folding frame 5 is able to drive two horizontal pillars 3 in a transverse direction to be folded in the transverse direction, and each longitudinal folding frame 6 is able to drive two vertical pillars 3 in a longitudinal direction to be folded in the longitudinal direction, such that four sides of the folding cart can be folded, and the six pillars 3 can be drawn close to each other, thus further reducing the space occupied by the folding cart in the folded stat and making the folding cart easy to carry when users go out. Fixing blocks 7 are mounted at top ends of the pillars 3, sliders 8 capable of sliding vertically are arranged on the pillars 3 and slide at lower ends of the pillars 3, lower ends of outer sides of the transverse folding frames 5 and the longitudinal folding frames 6 are hinged to the sliders 8, and upper ends of the outer sides of the transverse folding frames 5 and the longitudinal folding frames 6 are hinged to the fixing blocks 7. The fixing blocks 7 remain static, the sliders 8 slide vertically to drive the transverse folding frames 5 and the longitudinal folding frames 6 to be folded or unfolded, such that the folding cart can be easily folded or unfolded and be easily used by users.

The transverse folding frame 5 comprises two pairs of transverse rod assemblies 9 which are connected in a hinged manner, and the longitudinal folding frame 6 comprises two pairs of longitudinal rod assemblies 10 connected in a hinged manner. The transverse rod assembly 9 comprises a first transverse rod 11 and a second transverse rod 12 which are movably riveted together. The longitudinal rod assembly 10 comprises a first longitudinal rod 13 and a second longitudinal rod 14 which are movably riveted together.

Ends of the two adjacent first transverse rods 11 and the two adjacent second transverse rods 12 are hinged to fix inner ends of the two pairs of transverse rod assemblies 9, and ends of the two adjacent first longitudinal rods 13 and two the adjacent second longitudinal rods 14 are hinged to fix inner ends of the longitudinal rod assemblies 10. Outer ends of the transverse rod assemblies 9 are hinged to the fixing blocks 7 at the top ends of the pillars 3 by means of the first transverse rods 11 and hinged to the sliders 8 at the lower ends of the pillars 3 by means of the second transverse rods 12, thus being fixed. Outer ends of the longitudinal rod assemblies 10 are hinged to the fixing blocks 7 at the top ends of the pillars 3 by means of the first longitudinal rods 13 and hinged to the sliders 8 at the lower ends of the pillars 3 by means of the second longitudinal rods 14, thus being fixed.

The bottom folding frame 5 comprises a connecting seat 15 located at the center and four bottom rods 16, wherein an inner end of each bottom rod 16 is hinged to the connecting seat 15 at the center, a fixing member 17 is connected to an outer end of each bottom rod 16 in a hinged manner and mounted at a bottom end of the corresponding pillar 3, and outer ends of the bottom rods 16 are connected to the bottom ends of the corresponding pillars 3 by means of the fixing members 17. The sliders 8 slide between the fixing members 17 and the fixing blocks 7, and the fixing members 17 abut against the sliders 8 to fulfill a buffer effect when the sliders 8 slide to the bottom. The design of the two pairs of bottom folding frames 5 further enlarges the storage space of the folding cart, such that more items can be placed on the cart.

The connecting seat 15 is provided with a plurality of hinge slots 18 which are open downwards, and the bottom rods 16 are hinged in the hinge slots 18. The hinge slots 18 are open downwards, such that the bottom rods 16 can only rotate downwards, and the connecting seat 15 can be pulled upwards to fold the cart. When the connecting seat 15 is pulled upwards, the bottom rods 16 rotate downwards to drive the corresponding pillars 3 to move close to each other.

A pull frame 19 is arranged at a front end of the frame 1 and comprises a fixing seat 20, connecting rods 22 located on two sides of the fixing seat 20, and a pull rod 21 hinged to the fixing seat 20, wherein inner ends of the connecting rods 22 are hinged to the fixing seat 20, and outer ends of the connecting rods 22 are hinged to the fixing members 17 on two sides. When the pulling frame 19 is folded, the two connecting rods 22 rotate downwards with the fixing members 17 as the center, and the fixing seat 20 moves downwards and drives the pillars 3 on two sides to move close to each other. The pull rod 21 is hinged to a front end of the fixing seat 23 and is rotatable to allow users of different heights to pull the cart.

A grip ring 23 is arranged at a top end of the pull rod 21, and users hold the grip ring 23 to pull the cart. Brake pedals 24 are arranged at a front end of the frame 1 and located above the two casters 2 at the front end of the frame 1, and users can stop the cart in case of large inertia by stepping on the brake pedals 24.

For those skilled in the art, it is obvious that the invention is not limited to details of the above illustrative embodiments and can be implemented in other specific forms without deviating from the spirit or basic features of the invention. Therefore, no matter from which point of view, the above embodiments should be construed as illustrative rather than restrictive, and the scope of the invention should be defined by the appended claims rather than the above description and aims to include all variations falling within the concept and scope of equivalents of the claims. Reference signs in the claims should not be construed as limiting the claims involved.

What is claimed is:

1. A folding cart, comprising:
a frame;
a plurality of casters mounted at a bottom of the frame;
wherein the frame comprises a plurality of pillars, a plurality of pairs of bottom folding frames hinged to the pillars, and a plurality of pairs of transverse folding frames and longitudinal folding frames hinged between the pillars;
wherein fixing blocks are mounted at top ends of the pillars;
wherein sliders are arranged on the pillars and slide at lower ends of the pillars;
wherein lower ends of outer sides of the transverse folding frames and the longitudinal folding frames are hinged to the sliders;
wherein upper ends of the outer sides of the transverse folding frames and the longitudinal folding frames are hinged to the fixing blocks; and
wherein the sliders slide vertically to drive the transverse folding frames and the longitudinal folding frames to be folded or unfolded.

2. The folding cart according to claim 1, wherein the transverse folding frame comprises a plurality of pairs of transverse rod assemblies which are connected in a hinged manner, and the longitudinal folding frame comprises a plurality of pairs of longitudinal rod assemblies connected in a hinged manner.

3. The folding cart according to claim 2, wherein the transverse rod assembly comprises a first transverse rod and a second transverse rod which are movably riveted together, and the longitudinal rod assembly comprises a first longitudinal rod and a second longitudinal rod which are movably riveted together.

4. The folding cart according to claim 3, wherein ends of two adjacent said first transverse rods and two adjacent said second transverse rods are hinged to fix the transverse rod assemblies; ends of two adjacent said first longitudinal rods and two adjacent said second longitudinal rods are hinged to fix the longitudinal rod assemblies; the first transverse rods are hinged to the fixing blocks at the top ends of the pillars, and the second transverse rods are hinged to the sliders at the lower ends of the pillars; and the first longitudinal rods are hinged to the fixing blocks at the top ends of the corresponding pillars, and the second transverse rods are hinged to the sliders at the lower ends of the corresponding pillars.

5. The folding cart according to claim 1, wherein the bottom folding frame comprises a connecting seat at a center and a plurality of bottom rods, and inner ends of the bottom rods are hinged to the connecting seat.

6. The folding cart according to claim 5, wherein fixing members are connected to outer ends of the bottom rods in a hinged manner and mounted at bottom ends of the corresponding pillars, and the outer ends of the bottom rods are connected to the bottom ends of the corresponding pillars by means of the fixing members; and the sliders slide between the fixing members and the fixing blocks.

7. The folding cart according to claim 5, wherein the connecting seat is provided with a plurality of hinge slots which are open downwards, and the bottom rods are hinged in the hinge slots.

8. The folding cart according to claim 1, wherein a pull frame is arranged at a front end of the frame and comprises a fixing seat, connecting rods located on two sides of the fixing seat, and a pull rod hinged to the fixing seat, inner ends of the connecting rods are hinged to the fixing seat, and outer ends of the connecting rods are hinged to fixing members on two sides.

9. The folding cart according to claim 8, wherein a grip ring is arranged at a top end of the pull rod.

10. The folding cart according to claim 1, wherein brake pedals are arranged at a front end of the frame and located above the casters at the front end of the frame.
